(19) United States
(12) Patent Application Publication
(10) Pub. No.: US 2026/0300007 A1
(43) Pub. Date: Oct. 1, 2026

(54) METHOD AND SYSTEM FOR PROVIDING IMPROVED MEMORY MANAGEMENT IN A PORTABLE COMPUTING DEVICE (PCD)

(71) Applicant: Qualcomm Incorporated, San Diego, CA (US)

(72) Inventors: Ejebagom OJOGBO, San Diego, CA (US); Andrew Edmund TURNER, San Diego, CA (US)

(21) Appl. No.: 19/091,529

(22) Filed: Mar. 26, 2025

(51) Int. Cl. G06F 9/50; G06F 12/02

(52) U.S. Cl. CPC G06F 9/5016; G06F 9/5022; G06F 12/0246

(57) ABSTRACT

A memory management method and system for a portable computing device includes a processor executing an application program. The method and system may further include an operating system for supporting functions of the processor and the application program. The method and system may also include a hardware allocator coupled to the operating system and the processor for receiving one or more memory requests from at least one of the operating system, a user application executed by the processor, and the processor. The hardware allocator allocates memory in a first virtual memory and in a second virtual memory based on the memory requests. And the hardware allocator also allocates physical memory in a main memory device based on the memory requests.

### DESCRIPTION OF THE RELATED ART

For conventional portable computing devices (PCDs), physical memory is allocated and managed by the operating system (O/S) with the help of specialized software for translating virtual memory addresses. Such software (SW) based memory management makes memory allocation slow, with potential negative implications for SW applications (Apps) running on the PCD.

Applications running on a PCD with large memory and low latency requirements are often forced to do most of their memory allocation at startup, and are usually unable to release this memory during execution without degrading an application's performance. Additionally, dynamic memory allocators in conventional PCDs usually have to employ complex algorithms to manage allocated memory and reduce an application's likelihood of requesting more memory from the O/S while executing an application.

Large upfront allocations for applications running on PCDs usually lead to slow application launch times and often force the O/S to either kill other applications or swap their data to persistent storage due to insufficient memory. Another problem with conventional memory management is associated with the O/S assisting with virtual memory.

In most conventional O/S's of PCDs, virtual memory is usually used in variable-sized large blocks, but at the granularity of small fixed-size physical pages. These small fixed-size physical pages often lead to large page tables and complicated address translation hardware (H/W).

Large page tables for fixed-size physical pages and complicated HW make translation look ahead buffer (TLB) misses more costly for a PCD. Such misses often negatively affects program performance. Accordingly, it would be desirable to provide an improved memory management method and system that may increase the speed at which memory is allocated and supported for application programs running on PCDs.

### SUMMARY OF THE DISCLOSURE

Systems, methods, and other examples are disclosed for providing improved memory management for a portable computing device (“PCD”).

A memory management system for a portable computing device includes a processor executing an application program. The system may further include an operating system for supporting functions of the processor and the application program. The system may also include a hardware allocator coupled to the operating system and the processor for receiving one or more memory requests from at least one of the operating system, a user application executed by the processor, and the processor. The hardware allocator allocates memory in a first virtual memory and in a second virtual memory based on the memory requests. And the hardware allocator also allocates physical memory in a main memory device based on the memory requests.

The first virtual memory may be mapped into the second virtual memory. The first virtual memory may comprise variable sized virtual blocks for supporting the memory requests. The first virtual memory may be divided into a plurality of equal sized memory areas where each memory comprises the variable sized virtual blocks.

The hardware allocator may receive a memory deallocation request from either the operating system or a user application or processor, and then deallocates the physical memory in the main memory device based on the deallocation request and without any changes made to the first virtual memory.

A memory management method for a portable computing device may include providing a processor and an operating system and coupling the operating system and the processor to a hardware allocator. With the processor, an application program may be executed. One or more memory requests may be generated with at least one of the processor, the application program, or the operating system. The one or more memory requests may be received with the hardware allocator. The hardware allocator may allocate memory in a first virtual memory and in a second virtual memory based on the one or more memory requests. And the hardware allocator may also allocate physical memory in a main memory device based on the memory requests.

A memory management system for a portable computing device may include a plurality of processors. Each processor may execute an application program. The system may also include an operating system for supporting functions of the processors and the application programs. A hardware allocator may be coupled to the operating system and the processor.

The hardware allocator may comprise a plurality of local allocators, where each local allocator is assigned to a single, different processor. The hardware allocator may receive one or more memory requests from at least one of the operating system, an application program, and the processors. The hardware allocator may allocate memory in a first virtual memory and in a second virtual memory based on the memory requests. The hardware allocator may also allocate physical memory in a main memory device based on the memory requests.

The hardware allocator may receive a memory deallocation request from at least one of the operating system, an application program, and a processor. And the hardware allocator may deallocate the physical memory in the main memory device based on the deallocation request and without any changes made to the first virtual memory.

These and other features and advantages will become apparent from the following description, drawings and claims.

### BRIEF DESCRIPTION OF THE DRAWINGS

In the Figures, like reference numerals refer to like parts throughout the various views unless otherwise indicated.

FIG. 1A illustrates a functional block diagram of a system in accordance with a representative embodiment for providing improved memory management for a portable computing device;

FIG. 1B illustrates another functional block diagram of the system of FIG. 1A but now with data associated with the memory requests made in FIG. 1A being received by the HW allocator, virtual memory, and the physical memory device;

FIG. 1C illustrates another functional block diagram of the system of FIGS. 1A-1B but now showing how data stored in the physical memory blocks may be deleted quickly based on signals received from the O/S;

FIG. 2 illustrates another functional block diagram of the system for providing improved memory management and which provides further details of the HW allocator block 115 of FIGS. 1A-1C;

FIG. 3 illustrates an exemplary memory layout/mapping in which the system for providing improved memory management has two virtual memory spaces: a plurality of private virtual memories (PVM) each managed by a local allocator and a single global address space managed by the global allocator;

FIG. 4 illustrates an exemplary memory layout/mapping, similar to FIG. 3 but presented without illustrating the hardware elements as well as the physical page table, and in which the improved memory system has the two types of virtual memory spaces: a plurality of private virtual memories (PVM) that is a first type and a single global address space that is a second type;

FIG. 5 is another functional block diagram of the system for providing improved memory management and which further illustrates details of each local allocator block of FIG. 2 as well as the details for the global allocator block and the physical allocator block 220 of FIG. 2;

FIG. 6 illustrates a signaling sequence/flow diagram which provides a two stage parallel lookup performed by each local allocator of FIG. 5;

FIG. 7 illustrates a logical flow chart for a method and system for managing memory of a portable computing device (PCD) according to one exemplary embodiment; and

FIG. 8 illustrates an example of a portable computing device (“PCD”) in which exemplary embodiments of systems, methods, computer-readable media, and other examples of the inventive principles and concepts of the present disclosure may be implemented.

### DETAILED DESCRIPTION

In the following detailed description, for purposes of explanation and not limitation, exemplary, or representative, embodiments disclosing specific details are set forth in order to provide a thorough understanding of an embodiment according to the present teachings.

The word “exemplary” is used herein to mean “serving as an example, instance, or illustration.” The words “illustrative” or “representative” may be used herein synonymously with “exemplary.”

Any aspect described herein as “exemplary” is not necessarily to be construed as preferred or advantageous over other aspects. However, it will be apparent to one having ordinary skill in the art and having the benefit of the present disclosure that other embodiments according to the present teachings that depart from the specific details disclosed herein remain within the scope of the appended claims.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements'relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory device”, as that term is used herein, is intended to denote a non-transitory computer-readable storage medium that is capable of storing computer instructions, or computer code, for execution by one or more processors. References herein to a “memory device” should be interpreted as including one or more memory devices.

A “processor”, as that term is used herein, encompasses an electronic component that carries out tasks in hardware, software, and/or firmware. For example, a processor can be an electronic component that is programmed to execute a computer program or executable computer instructions.

A processor can also be an electronic component comprising one or more state machines. A processor may be a multi-core processor comprising multiple processing cores. A processor may also refer to a collection of processors within a single system or distributed amongst multiple systems. A processor could also refer to a digital signal processor (“DSP”).

A “controller”, as that term is used herein, can mean, for example, a processor, such as a multi-core microprocessor, a microcontroller, or a DSP.

The term “logic”, as that term is used herein, means circuitry that is programmed or configured by software and/or firmware to perform particular operations. For example, logic gates of logic arrays, state machines or processors are examples of “logic”, as that term is used herein. The term “circuit” or “circuitry”, as those terms are used herein, denote electrical circuitry comprising analog and/or discrete circuit elements or components.

A portable computing device (“PCD”) may include a laptop or palmtop computer, a cellular telephone or smartphone, a personal digital assistant (“PDA”), a navigation device, a smartbook, a portable game console, a satellite telephone, an automotive device, and an Internet-of-Things (IoT) device, etc.

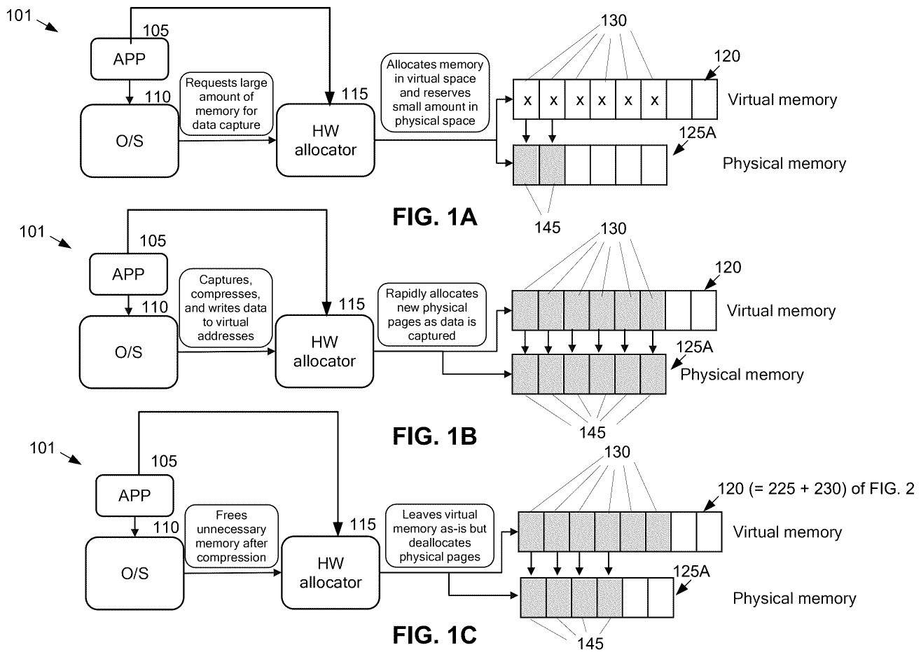

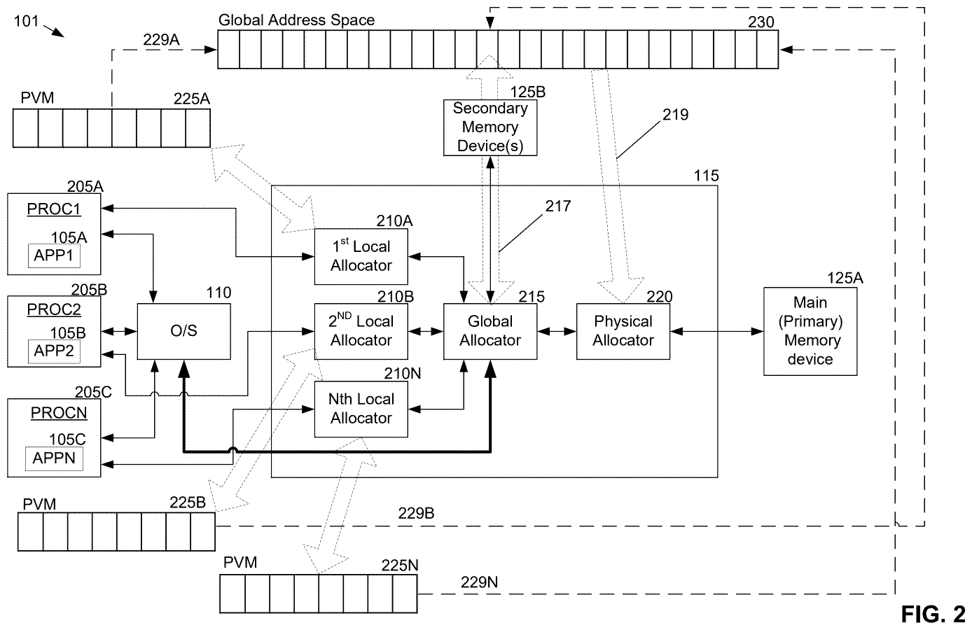

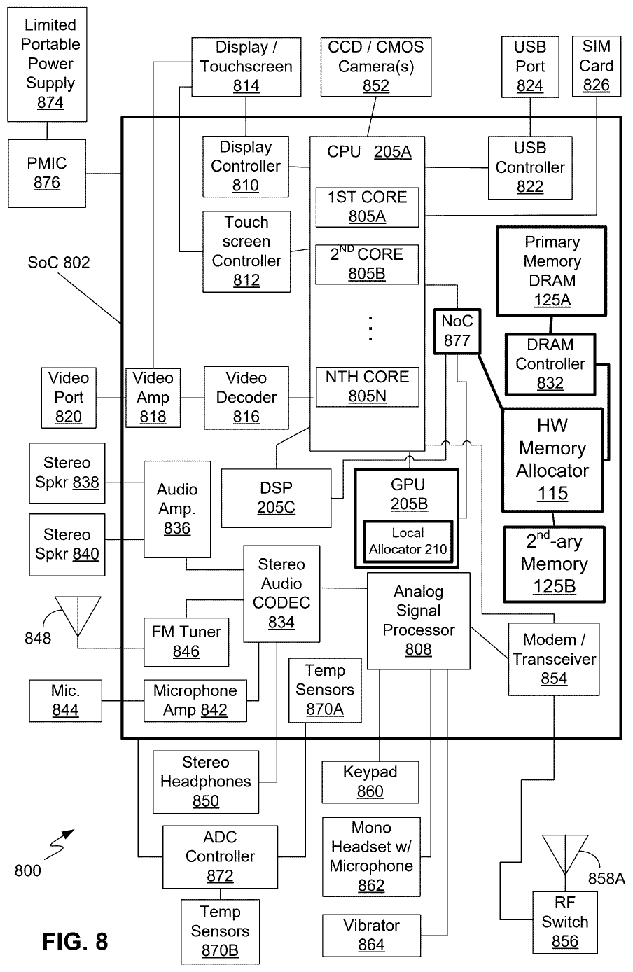

Referring now to FIG. 1A, this figure illustrates a functional block diagram of a system 101 in accordance with a representative embodiment for providing improved memory management for a portable computing device (“PCD”) 800 (see FIG. 8). The system 101 may include application (APP) software 105 running on a processor 205 (see FIG. 2) within a PCD 800 which communicates with directly with a hardware (HW) allocator 115 and an operating system (O/S) 110 of the PCD 800 for memory requests.

The O/S 110 may receive and process memory allocation requests from the APP 105 or processor 205 and transmit those requests to a hardware (HW) allocator 115. The APP 105 or processor 205 may also communicate memory requests directly to the HW allocator 115. The HW allocator 115 may allocate the memory requested by the APP 105 by assigning/ear-marking/reserving memory blocks 130 in a virtual memory space 120.

The six virtual memory blocks 130 in the virtual memory space 120 in this simplified example of FIG. 1A which have “x” marks have been reserved by the HW allocator. Those memory blocks 130 of the virtual memory space 120 without any “x” marks are not reserved.

And the hardware allocator 115 may also reserve a smaller amount of physical memory blocks 145 in a physical memory device 125A. In the simple example of FIG. 1, physical memory blocks 145 with gray shading have been allocated. Those physical memory blocks 145 without gray shading have not been allocated by the HW allocator 115.

The physical memory device 125A may comprise volatile memory, such as, but not limited to, Double Data Rate (“DDR”) Synchronous Dynamic Random Access Memory (“SDRAM”). Other volatile memory may include static random access memory (“SRAM”).

However, other memory devices 125A beside volatile are possible for the memory device 125A and are included within the scope of this disclosure. Thus, the physical memory device 125A may also comprise non-volatile memory or a combination of volatile and non-volatile memory, as understood by one of ordinary skill in the art.

Referring now to FIG. 1B, this figure is another functional block diagram of the system of FIG. 1A but now showing data associated with the memory requests made in FIG. 1A being received by the HW allocator 115, virtual memory 120, and the physical memory device 125A. In this FIG. 1B, the application 105 running on a processor 205 (see FIG. 2) may compress data and issue write requests to the HW allocator 115 (via the O/S 110 or directly to the HW allocator 115) to write the data to virtual addresses in the virtual memory area 120.

Specifically, the six gray shaded virtual memory blocks 130 indicate that data from the application software 105 has been received and stored by the HW allocator 115 in these virtual memory blocks 130. Those two virtual memory blocks 130 without any shading do not have any data. Similarly, the HW allocator 115 stores data corresponding to the six shaded virtual memory blocks 130 in six memory blocks 145 of the physical memory device 125A.

Referring now to FIG. 1C, this figure is another functional block diagram of the system of FIGS. 1A-1B but now showing how data stored in the physical memory blocks 145 may be quickly deleted based on signals received from the O/S 110 or directly from an application program 105 or processor 205. In this FIG. 1C, after the application program 105 has finished writing its data, in FIG. 1B, the application program 105 may determine that some of the data it sent to its virtual memory 120 is unnecessary.

To make this determination, the application program 105 may look at is own virtual memory 120 to decide if data transmitted for a write request was unnecessary. The application program 105 (i.e. “user process”) may communicate to the O/S 110 which data previously transmitted to it was unnecessary. The O/S 110 may relay this information from the application program 105 about unnecessary or unneeded data to the HW allocator 115. The application program 105 may also communicate this information directly to the HW allocator 115.

The HW allocator 115 may leave the virtual memory 120 alone or it may delete the unnecessary data at its discretion. The HW allocator 115 in response to receiving this unnecessary data from the application program 105 or the O/S 115 will usually deallocate the memory blocks 145 of the physical memory 125A containing the unnecessary data so that these memory blocks 145 may be used by other application programs 105 (i.e. other “user processes”).

In the simplified example of FIG. 1C, comparing it to FIG. 1B, the HW allocator 115 has deleted data from the last two memory blocks 145 of the six memory blocks 145 illustrated. These last two memory blocks which do not have any gray shading are empty and ready to receive new data. Meanwhile, those four memory blocks 145 of the physical memory device 125A with gray shading are filled and contain data.

FIG. 1C illustrates how the hardware-based memory system 101 may support lossless footprint compression, where the system 101 has the ability to rapidly allocate and deallocate physical pages (i.e. memory blocks 145 of the memory device 125A) which can only be achieved using a HW allocator 115. Physical pages corresponding to the virtual memory blocks 130 and the physical memory blocks 145 can be dynamically allocated based on consumed virtual addresses of the virtual memory space 120, and then deallocated at an application program's request (i.e. a user process request) without affecting the virtual memory space 120.

The virtual memory space 120 of FIG. 1C has also been identified with reference characters 225, 230 (see FIG. 2). These two reference characters 225, 230 to indicate that the virtual memory space 120, as described in more detail below, may be supported by two different virtual address spaces 225, 230 of FIG. 2.

Referring now to FIG. 2, this figure is another functional block diagram of the system 101 for providing improved memory management and which illustrates further details of the HW allocator block 115 of FIGS. 1A-1C. The system 101 may comprise application programs 105 running on one or more processors 205. The processors 205 may comprise any one of: a central processing unit (CPU); a CPU may be a multi-core CPU; a graphical processing unit (GPU); a neural processing unit (NPU); a digital signal processor (DSP), and/or other like processors known as of this writing. The application programs 105 may be referred to as user processes, and they may communicate with the operating system (O/S) 110 as described previously in connection with FIGS. 1A-1C.

The O/S 110 may communicate with the HW allocator 115 as described previously. The HW allocator 115 may comprise one or more local allocators 210 (i.e. 210A, 210B, 210N, where N is an integer); a global allocator 215; and a physical allocator 220. The three allocators 210, 215 & 220 of FIG. 2 may comprise logic to perform their functions as will be described in more detail below.

As mentioned above, “logic” means circuitry that is programmed or configured by software and/or firmware to perform particular operations. For example, logic gates of logic arrays, state machines or processors are examples of “logic”, as that term is used herein. The term “circuit” or “circuitry”, as those terms are used herein, denote electrical circuitry comprising analog and/or discrete circuit elements or components.

The O/S 110 may communicate directly with the global allocator 215. Specifically, the O/S 110 communicates with the global allocator 215 when creating and killing/removing application programs 105, and the application programs 105 and processors 205 communicate with the local allocators 210 when issuing new memory requests.

The global allocator 215 communicates directly with the physical allocator 220. The physical allocator 220 communicates directly with a main or primary memory device 125A.

The main or primary memory device 125A (hereafter “main memory device” 125A) may comprise the memory device as described previously in connection with FIGS. 1A-1C, which may include, but is not limited to, DDR SDRAM; SDRAM; DRAM; SRAM; and other volatile memories, as well as non-volatile memories, or any combination of volatile and non-volatile memory, as understood by one of ordinary skill in the art.

Meanwhile, the global allocator 215 may communicate directly with one or more secondary memory devices 125B. These secondary memory devices 125B may comprise any type of caches, such as, but not limited to level 1 (L1), level 2 (L2), and level 3 (L3), and system cache types, as well as tightly coupled memory (TCM). A TCM may comprise random access memory (“RAM”) or any other type of volatile or even non-volatile memory as understood by one of ordinary skill in the art. Generally, these secondary memory devices 125 have capacities significantly less than that of the primary memory device 125A. However, the secondary memory devices 125B may provide for increased speed of access for the global allocator 215 compared to the speed of access by the global allocator 215 with the primary memory device 125A.

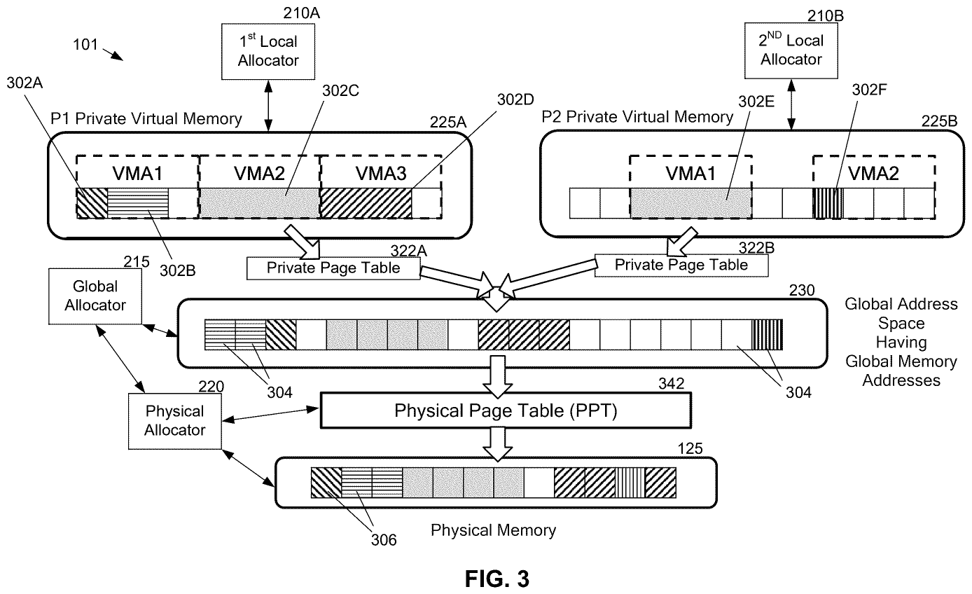

Each local allocator 210 may handle virtual memory allocation and translation requests for each application program 105 (i.e. “user process”) running on a processor 205. While a specific allocator 210 may not perform virtual memory allocation, all local allocators 210 will handle virtual memory translation. Generally, a single allocator 210 is assigned to a single processor 205, where a processor 205 may be characterized as a “client” relative to its assigned single allocator 210. Each allocator 210 may reside within or be locally associated with a processor 205 or may be externally connected to it. Each allocator 210 may accelerate address translation for its client(s) and each may store a client's recently allocated/accessed virtual address. Each allocator 210 may maintain a local pool of global memory addresses 315 (see FIG. 3).

As will be described in more detail below, each local allocator 210 may support and maintain a private virtual memory (PVM) 225 for each of the application programs 105 (i.e. “user processes”) running on a single processor 205 assigned to a single local allocator. Each PVM 225 maps into a global address space 230 as indicated by dashed arrows 229A-N. As noted above, the global address space 230, which is also virtual memory, may be supported by the global allocator 215 and the secondary memory devices 125B.

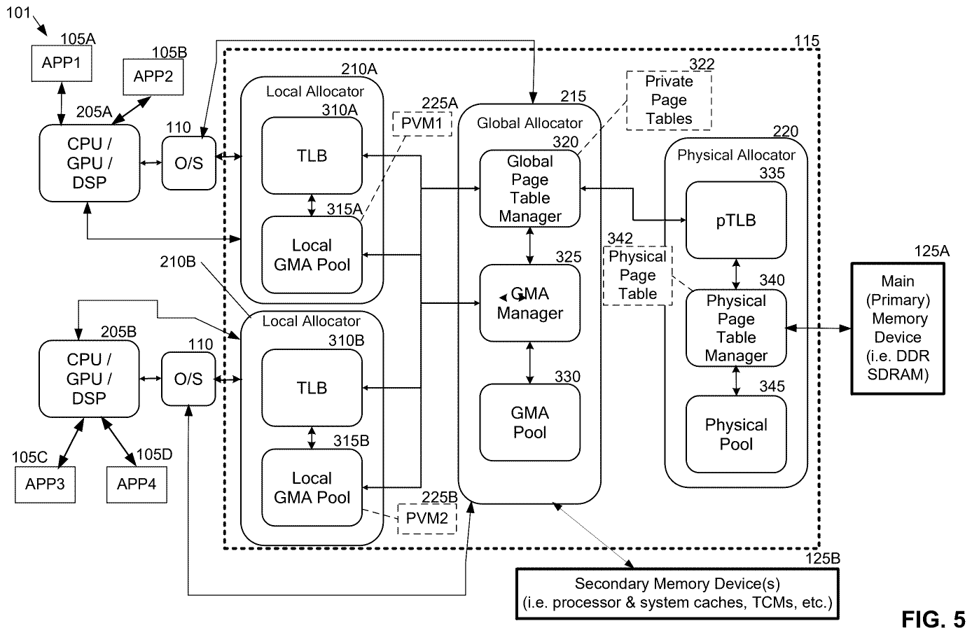

The global allocator 215 may communicate directly with the O/S 110 to perform memory management for all application programs 105 running on the processors 205. The global allocator 215 may track and allocate new virtual global memory allocations in the global address space 230. Parts of this global address space 230 managed by the global allocator 215 may be stored on the secondary memory devices 125B (i.e. caches) described above, which typically provide faster memory access compared to the primary memory device 125A (i.e. DDR SDRAM memory). The global allocator 215 may maintain a private page table 322 for each application 105 to track the mappings from an application's PVM 225 to the global address space 230. All of these page tables 322 are created/managed by the global allocator 215 via the global page table manager 320 (see FIG. 5).

The global address space 230 maintained by the global allocator 215 may be mapped as indicated by dashed arrow 219 to a physical page table 342 (see FIG. 3) that is maintained by the physical allocator 220. The physical allocator 220 communicates directly with the main or primary memory device 125A (i.e. DDR SDRAM) to write and read memory requests from the application programs 105.

The physical allocator 220 as illustrated in FIG. 2 will support accesses to the primary memory device 125A. Such physical accesses may require translation/allocation from the global address space 230 using the physical page table 342, but this access to the primary memory device 125A will generally only occur when necessary (e.g., on a miss from the secondary memory devices 125B or when accessing memory mapped files). In other words, a majority of read and write memory requests may be completed with just the global address space 230 and without any access to the primary memory device 125A

Referring now to FIG. 3, this figure illustrates an exemplary memory layout/mapping in which the system 101 for providing improved memory management has two virtual memory spaces: a plurality of private virtual memories (PVM) 225 each managed by a local allocator 210 and a single global address space 230 managed by the global allocator 215. As noted in connection with FIG. 2, each local allocator 210 may manage a first type of virtual memory space identified as private virtual memory (PVM) 225 dedicated to an application program 105 running on a single processor 205 (see FIGS. 1-2).

That is, a PVM 225 is created for each (i.e. one or a single) application program 105, and generally, not for each processor 205. Local allocators 210, however, are provided for each processor 205. For example, in the case/situation/configuration of a multi-core CPU 205, while it would have a single local allocator 210, that allocator 210 would be responsible of all the PVMs 225 for all the applications running on that multi-core CPU 205. Other processors 205, like GPUs 205B (see FIG. 8) usually only have one application program 105 running at a time, so in their case/situation, there is one PVM 225 per the local allocator 210 assigned to the GPU 205B.

As illustrated in FIG. 3, there are two private virtual memories (PVMs) 225A, 225B provided: each PVM 225 is assigned to a single local allocator 210; and each PVM 225 tracks memory consumed by respective applications 105 (see FIGS. 1-2) running on a single processor 205 (see FIGS. 1-2). That is, there is a 1:1 correlation among each PVM 225 and a local allocator 210 in FIG. 3. Similarly there is a 1:1 correlation for a local allocator 210 assigned to its single processor 205.

However, in the situation of a CPU 205 running multiple applications 105, the CPU 205 may have only one local allocator 210. But each application would have a PVM 225 and so there would be a many-to-1 (i.e. many:1) correlation between PVMs 225 and a local allocator 210 as mentioned above.

According to another feature of the improved memory management system 101, each PVM 225 may be divided into equally sized virtual memory areas (VMAs). So according to the exemplary embodiment illustrated FIG. 3, the first PVM 225A is divided into three equally sized VMAs, such that the PVM 225A has a first VMA1, a second VMA2, and a third VMA3.

Meanwhile, the second PVM 225B has been divided into only two equally sized VMAs, where the second PVM 225B has a first VMA1, and a second VMA2. Generally, all VMAs across all PVMs 225 are provided with a same size. As one example, each VMA in both the first PVM 225A and second PVM 225B may have a size of one gigabyte ( 1GB), or two gigabytes (2 GBs), or any other size greater or less than these as understood by one of ordinary skill in the art.

Each local allocator 210 may allocate memory of each VMA using variable-sized virtual blocks 302. That is, unlike the conventional art which utilizes fixed-sized virtual blocks (i.e. usually 4 KB sized blocks), each local allocator 210 may allocate memory requests for a first application program 105 (i.e. a first user process) using a virtual block size that may be different in size relative to second application program 105 (i.e. a second user process).

For example, suppose that each VMA of FIG. 3 has been assigned a size of 1 Gigabyte (1 GB). And the first local allocator 210A of FIG. 3 may allocate memory for a first application program 105 running on a first processor 205A (see FIG. 2) with a 250MB sized first virtual block 302A of the first VMA1. Similarly, the first allocator 210A of FIG. 3 may later allocate more memory for the same application program 105 running on the first processor 205A with a different sized virtual block 302B compared the first virtual block 302A, such as 500 MB.

The patterns and gray scale shading of FIG. 3 have been proportionally sized to demonstrate each of the exemplary different sizes of the variable sized virtual blocks 302. As noted above, and as an example if each VMA of each PVM 225 has been assigned a fixed size of 1 Gigabyte (1 G): the first virtual block 302A of the first VMA1 of the first PVM 225A could have a size of 250 MB, while the second virtual block 302B of the first VMA1 of the first PVM 225A could have a size of 500 MB; a third virtual block 302C of the second VMA2 of the first PVM 225A could have size of 1 G; and a fourth virtual block 302D of the third VMA3 of the first PVM 225A could have a size of 750 MB.

Similarly, like the first PVM 225A, a fifth virtual block 302E of a first VMA1 of the second PVM 225B may have a size of 1 GB; and a sixth virtual block 302F of a second VMA2 of the second PVM 225B may have a size of 250 MB. Again, these are just exemplary sizes to demonstrate how each variable sized virtual block 302 may have different sizes relative to other virtual blocks 302 within a PVM 225 and relative to other PVMs 225. This variable sized ability of these virtual memory blocks 302 may reduce the number of translations from virtual memory to physical memory for the memory system 101 as will be explained in more detail below.

And generally, the variable sized virtual memory blocks 302 of each VMA of a PVM 225 are assigned contiguous addresses. These contiguous addresses of the variable-sized virtual memory blocks 302 are translated/mapped to the global address space 230 with respective private page tables, where each local allocator 210 maintains one private page table for its application's PVM 225. As noted above, each application program 105 has its own PVM 225. The private page tables for each PVM 225 are created by the global allocator 215 using the global address space 230 as will be described in further detail below in connection with FIG. 5.

While the PVMs 225 may track memory requests with variable sized virtual blocks 302, the virtual global address space 230 which is maintained by the single global allocator 215 is divided into an appropriate number of equal-sized blocks, whose sizes match those of the pages in physical memory 306, and allocated individually. Unlike the contiguity of memory addresses for the variable sized virtual blocks 302 of each PVM 225 and their corresponding global memory pages 304, there is no guarantee of contiguity between the global memory pages 304 assigned to a virtual block 302 and their corresponding pages 306 in physical memory.

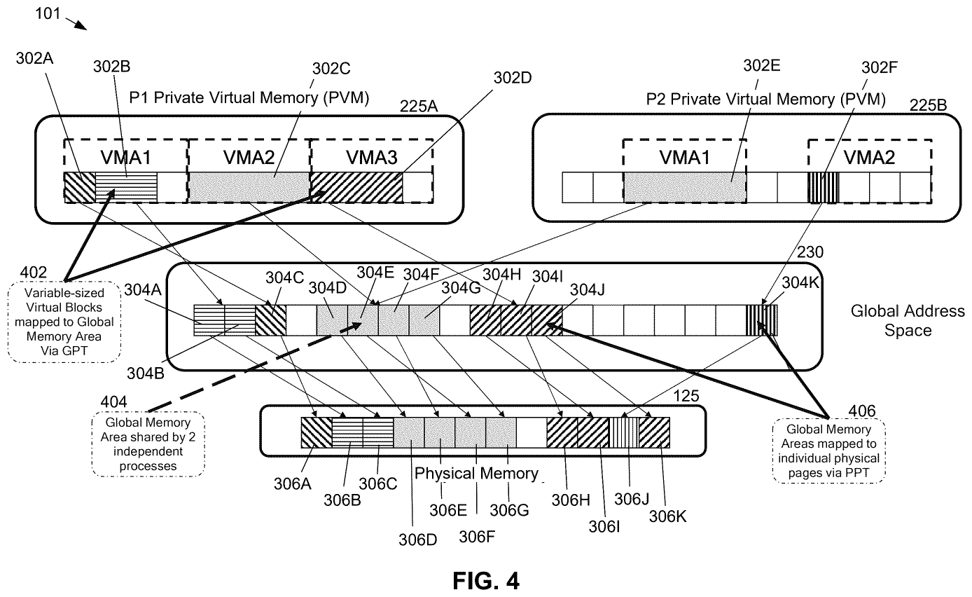

That is, as illustrated in FIG. 3 there may not be any contiguity of memory addresses between physical pages 306 within physical memory 125 and their corresponding contiguous blocks 304 in the global address space 230. However, it is possible for contiguity to occur within physical memory 125, but it is designed such that it does need to operate with contiguity as understood by one of ordinary skill in the art. Further details of how the variable sized virtual blocks 302 of each PVM 225 are mapped into the equal-sized pages of the global address space 230 using the private page tables 322 will be illustrated and explained in connection with FIG. 4.

A single physical page table 342 maps the virtual global address space 230 to the physical memory 125. The physical memory 125 has equal-sized pages 306, like the pages 304 of the virtual global address space 230. A single physical allocator 220 manages and maintains a single physical page table 342. The single physical page table 342 keeps track of all global-physical page mappings used by each application program 105 (i.e. each user process) supported by the system 101. Further details of how the global pages 304 of the virtual global address space 230 are mapped to the pages 306 of the physical memory 125 using the physical page table 342 will be illustrated and described in connection with FIG. 4.

Referring now to FIG. 4, this figure illustrates an exemplary memory layout/mapping, similar to FIG. 3. But FIG. 4 presents a memory layout without illustrating the hardware elements (i.e. allocators 210, 215) as well as the physical page table 342, and in which the improved memory system 101 has the two types of virtual memory spaces: a plurality of private virtual memories (PVM) 225 that is a first type and a single global address space 230 that is a second type. According to FIG. 4, arrows indicating memory assignments have been provided from each PVM 225, and specifically, from each variable sized virtual block 302 of a PVM 225 to one or more equally sized virtual page blocks 304 of the global address space 230.

Dashed box 402 identifies two instances of the mapping between the two virtual memory spaces (i.e. the PVMs 225 & the global address space 230). Looking at the first VMA1, the first variable sized virtual block 302A (which has a size that is 25% of the first VMA1 as shown in FIG. 4) in the first PVM 225A has been mapped to a single third virtual page block 304C of the global address space 230. Meanwhile, the second variable sized virtual block 302B (which has a size that is 50% of the first VMA1 as shown in FIG. 4) in the first PVM 225A has been mapped to the first virtual page block 304A and the second virtual page block 304B of the global address space 230. As noted previously, each of the virtual page blocks 304 of the global address space 230 have an equal size.

Similarly, the third variable sized virtual block 302C (which has a size that is 100% of the second VMA2) in the first PVM 225A has been mapped to four equal-sized virtual page blocks 304D-G of the global address space 230. The fourth variable sized virtual block 302D (which has a size that is 75% of the third VMA3) of the first PVM 225A has been mapped to three equal-sized virtual page blocks 304H-J of the global address space 230.

As noted above, the sizes of the variable sized virtual blocks 302 of each PVM 225 illustrated in FIGS. 3-4 are merely exemplary. Other sizes greater or small are possible and are well within the scope of this disclosure as understood by one of ordinary skill in the art.

Meanwhile, dashed box 404 of FIG. 4 identifies how a single global memory area comprising four virtual page blocks 304D-304G may be shared between the second VMA2 of the first PVM 225A and the first VMA1 of the second PVM 225B. This sharing of global memory areas between application programs 105 (i.e. user processes) may be supported by the O/S 110 communicating with the global allocator 215 as will be described in further detail below.

As noted previously, each PVM 225 may support a single application program 105 (see FIGS. 1-2) which is running on a single processor 205. Thus, dashed box 404 illustrates not only how two different application programs 105 (i.e. different processes) may share memory space, but this also shows how application programs 105 running on different processors (i.e. 205A, 205B) may share memory space, since PVM 225A is dedicated to a first application program 105A and PVM 225B is dedicated to a second application program 105B.

Dashed box 406 of FIG. 4 further illustrates how global memory areas in the global address space 230 may be mapped to physical pages of the physical or main/primary memory device 125A. Specifically, dashed box 406 illustrates how the three virtual page blocks 304H-J of the global address space 230 are mapped to three non-contiguous physical page blocks 306H, 306I, 306K of the physical or main/primary memory device 125A. Dashed box 406 also illustrates how the single virtual page block 304K of the global address space is mapped to the single physical page block 306J of the physical or main/primary memory device 125A.

As noted previously, the secondary memory devices 125B of FIG. 2 may store the first and second virtual memory spaces 225 & 230. The secondary memory devices 125B may comprise any type of caches, such as, but not limited to level 1 (L1), level 2 (L2), and level 3 (L3), and system cache types, as well as tightly coupled memory (TCM). Generally, these secondary memory devices 125 have capacities significantly less than that of the primary memory device 125A. However, the secondary memory devices 125B may provide for increased speed of access for the global allocator 215 compared to the speed of access by the global allocator 215 with the primary memory device 125A.

The primary memory device 125A supports the physical pages 306 mapped to the global address space 230 via the single physical page table (PPT) 342 described previously. As described previously, the primary/main memory device 125A may comprise volatile memory, such as, but not limited to, Double Data Rate (“DDR”) Synchronous Dynamic Random Access Memory (“SDRAM”).

Other volatile memory for the memory device 125A may include static random access memory (“SRAM”). However, other memory devices 125A beside volatile are possible for the main memory device 125A and are included within the scope of this disclosure. Thus, the physical memory device 125A may also comprise non-volatile memory or a combination of volatile and non-volatile memory, as understood by one of ordinary skill in the art.

Referring now to FIG. 5, this figure is another functional block diagram of the system 101 for providing improved memory management and which further illustrates details of each local allocator block 210 of FIG. 2 as well as the details for the global allocator block 215 and the physical allocator block 220 of FIG. 2. FIG. 5 is similar to FIGS. 1-2 so only the differences will be described and/or highlighted below.

Each processor block 205 has been shown to comprise at least one of a CPU, GPU, and a DSP. However, other processor types besides these three are possible and are included within the scope of this disclosure. Generally, each processor block 205 comprises a single HW device. Though, it is noted that a CPU 205 may comprise a multicore CPU 205, such as illustrated in FIG. 8 described below.

According to the exemplary embodiment illustrated in FIG. 5, each processor 205 may execute/run a plurality of application programs 105 (i.e. user processes). As shown in FIG. 5, the first processor 205A is running a first application program 105A and second application program 105B. The second processor 205B is running a third application program 105C and second application program 105D.

The O/S 110 may assign each application program 105 (i.e. “user process”) a process identifier (PID) number as understood by one of ordinary skill in the art. While the O/S 110 has been illustrated as two separate components/blocks 110 in FIG. 5, the O/S 110 comprises a single, unitary software program as understood by one of ordinary skill in the art.

The memory requested by the first application program 105A running on the first processor 205A of FIG. 5 may be allocated to variable sized virtual blocks 302A-302D of the first PVM 225A illustrated in FIG. 4. Similarly, the memory requested by the second application program 105B running on the first processor 205A of FIG. 5 may be allocated to the variable sized virtual blocks 302E-302F of the second PVM 225B illustrated in FIG. 4.

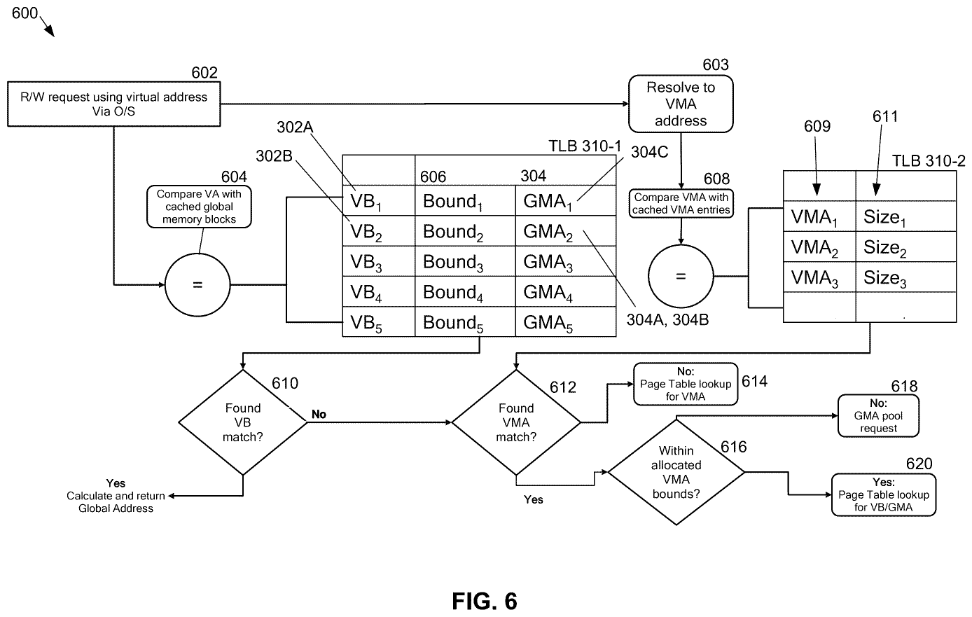

These allocations to the PVMs 225 are made by each local allocator 210. As shown in FIG. 5, each local allocator 210 may comprise a translation lookahead buffer (TLB) 310 and a local global memory address/area pool 315. Each TLB 310 caches a client's (i.e. an application program 105) recently allocated virtual addresses. Specifically, the TLB 310 is used to hold recent translations from variable sized virtual blocks 302 (see FIG. 4) to global addresses in the global address space 230 (see FIG. 4) as well as tracking the virtual memory areas (VMAs)(see FIGS. 3-4) corresponding to these recent translations. VMAs are stored in the TLB 310 with their present allocated size to enable quick/rapid allocation when necessary. Memory accesses from the application program 105 or processor 205 trigger a two-stage parallel look-up in the TLB 310. This two-stage parallel look-up in the TLB 310 will be described in more detail below in connection with FIG. 6.

While each TLB 310 may function similar to a conventional TLB with respect to translations, it is noted that each TLB 310 is translating a first virtual memory space (i.e. each PVM 225) into a second virtual memory space (i.e. the global address space). Meanwhile, as understood by one of ordinary skill in the art, most conventional TLBs convert a virtual memory space to a physical memory space.

The local global memory address (GMA) pool 315 maintained by each local allocator corresponds with the global address space 230 described previously. This local GMA pool 315 supports new variable sized virtual block-global memory address (GMA) allocations. That is, new variable sized virtual block-global memory address (GMA) allocations are taken from the GMA pool 315 maintained by each local allocator 210. When the local GMA pool 315 is low on addresses from the global address space 230 (see FIG. 4), the local allocator 210 may send a request to the global allocator 215, and specifically, to a global memory address (GMA) manager 325. The GMA manager 325 may provide a set of new GMA addresses in response to a low pool request from a local allocator 210.

When a local allocator 210 as shown in FIG. 5 is performing a new allocation, the size of each variable-sized virtual block 302 of the PVM 225 may be chosen by the local allocator 210 based on past memory usage. This selection of size by each local allocator 210 based on past memory usage of an application program 105 enables more efficient use of the global address space 230 (see FIG. 4) by each application program 105 (i.e. user processes with process IDs (PIDs)—see FIGS. 1-2). Each local allocator 210 may use execution-based heuristics (i.e. such as a simple allocation counter) to determine the sizes of new variable sized virtual blocks 302 (see FIGS. 3-4).

As shown in FIG. 5, one or more local allocators 210 are coupled to a single global allocator 215. The global allocator 215 may interface with the O/S 110 to perform memory management for all application programs 105 (i.e. user processes) running on a single chip/processor 205. The global allocator 215 may track and allocate new virtual-global address translations for application programs 105 as they execute. The global allocator 215 may maintain a central GMA pool 330 of global memory addresses from which it supplies local allocators 210 (i.e. local GMA pools 315) when necessary (i.e. receiving a low pool request from a local allocator 210).

The single global allocator 215 may comprise a global page table manager 320; a global memory address (GMA) manager 325; and a GMA pool 330. At process creation (i.e. for tracking an application program 105), the O/S 110 sends the process ID (PID) to the global allocator 215 along with allocation requests for the statically allocated portions of the process'virtual memory.

The Global Page Table Manager 325 within the global allocator 215 creates a private page table for each new application program 105 (i.e. user process) being tracked in the global address space 230 (see FIG. 4). The location of the process'(i.e. application program's) private page table in the global address space 230 (see FIG. 4) is indexed using a unique identifier generated from/with the PID.

Memory allocation requests from the O/S 110 are sent to a Global Memory Address (GMA) Manager 325. The GMA manager 325 may decide how many GMAs to allocate based on the sizes of requested memory from the O/S 110 and their potential locations in the global address space 230 (see FIG. 4).

GMA addresses are usually fetched and retrieved from the local GMA pool 315 of single local allocator 210 assigned to a PID (i.e. a local allocator 210 assigned to an application program 105). These GMA addresses from the local GMA pools 315 of local allocators 210 are transmitted to the Global Page Table Manager 320 after they have been allocated to an application program 105. The Global Page Table Manager 320 may store this information along with VMAs/variable-sized virtual blocks 302 associated with the GMA addresses.

The Global Page Table Manager 320 may program each private page table of an application program (i.e. each user process) with the new memory allocations. The global allocator 215 may also transmit GMA allocations back to the O/S 110 to keep it updated on how much memory each application program 105 is consuming/using.

Sharing memory between application programs 105 (i.e. user processes) may occur within the global address space 230 (see FIG. 4). Referring briefly back to FIG. 4, see situation block 404 where global address space blocks 304D-304G are shared between virtual blocks 302C & 302E of PVMs 225A & 225B. This situation block 404 of FIG. 4 is facilitated by the global allocator 215 of FIG. 5.

Referring back to FIG. 5, application programs 105 (i.e. user processes) may inform the O/S 110 of virtual blocks (i.e. blocks 302C of PVM 225A and 302E of PVM 225B of FIG. 4) they wish to share, and the O/S 110 communicates the corresponding GMA addresses of these blocks 304 (i.e. blocks 304D-304G of FIG. 4) to the global allocator 215. Application programs 105 are, generally, only aware of their assigned (i.e. single) private virtual memory 225. It is generally up to the O/S 110 and/or the global allocator 215 to determine the global memory addresses of global address space 230 that correspond to the desired shared regions (i.e. shared blocks 304D-304G of FIG. 4). The global allocator 215 may also receive a signal from the O/S 110 to query the private page table of the sharing process to obtain the GMA addresses for the shared blocks 304.

The global allocator 215 programs/assigns these shared GMA addresses into the private page tables of the other processes (i.e. application programs 105) sharing the memory. Either the global allocator 215 or the O/S may maintain a count of how many application programs 105 (i.e. user processes) are sharing a particular GMA (like shared blocks 304D-304G of FIG. 4), allowing de-allocation of the global address space 230 (see FIG. 4) once all application programs 105 (i.e. user processes) using the GMAs are terminated.

The global allocator 215 generally communicates with the O/S 110 in order to manage an application program's (i.e. user process') memory usage. During process execution, new GMA allocations issued by local allocators 210 are sent to the global allocator 215 to be added to the process' private page tables maintained by the global allocator 215 in the global address space 230 (see FIG. 4).

Each new GMA allocation of the global address space 230 is tracked and compared against a threshold for that user process, where the threshold is assigned by the O/S 110. New GMA allocations may also be sent to the O/S 110, enabling it to maintain a per-program 105 (i.e. per process) list of GMAs allocated. When allocations reach or exceed the predetermined threshold as measured by a local allocator 210, the local allocator 210 notifies the O/S 110 so that it can make a decision on what to do with respect to memory for the application program 105 (i.e. user process).

The O/S 110 may decide to free/de-allocate certain GMAs from the global address space 230, compress data in physical memory, or terminate the user process (i.e. application program 105) if it is using too much memory (i.e. exceeds the O/S threshold). To free GMA memory or to terminate an application program 105 (i.e. user process), the O/S 110 may send a signal to the global allocator 215 along with the process ID, enabling the global allocator 215 to find and modify the process' page tables within the global address space 230 (see FIG. 4) and return the freed GMAs to the GMA pool 330.

To compress or free physical memory 125A, the O/S 110 queries its list of the process'GMAs and sends these GMAs to the physical allocator 220, which is in charge of managing physical memory (i.e. the main memory device 125A). A list of GMAs attached to a process (i.e. associated with an application program 105) may also be managed and tracked by the global allocator 215. The global allocator 215 may send these GMA addresses directly to the physical allocator 220.

Additionally, application programs 105 (i.e. user processes) of FIG. 5 may signal the hardware allocator 115 to free the physical memory attached to certain VB-GMA pairs, achieving footprint compression in physical memory without changes to their PVM 225 (see FIGS. 3-4). This signaling for freeing physical memory 125A (see also FIG. 1C) may be completed via direct calls to the hardware allocator 115 by application programs 105 or the by the hardware blocks 205 executing the user process.

The signaling for freeing physical memory 125A (see also FIG. 1C) may also be completed via a software/system call through the OS 110, which would send the request to the global allocator 320. The global allocator 320 will get the GMA addresses for the selected virtual blocks of the application program 105 and send them to the physical allocator 220 for de-allocation. GMA addresses may be sent to the physical allocator 220 either as ranges of addresses (i.e. the start and end addresses of the GMA) or in individual chunks at the granularity of the physical page size stored in the main memory device 125A.

In other words, the process of freeing physical memory 125A can be completed by either software (SW) or hardware (HW) calls. In particular, a direct HW call to the allocator HW 115 of FIG. 5 is at least one important feature of the system 101. This HW call may be achieved via the use of new transaction types that communicate the free instruction from the application 105 and/or the processor 205 to the HW allocator 115 via wires or through a network-on-chip (NoC).

As one example, a camera module 852 (see FIG. 8) capturing and compressing data for a camera user process 105 and then sending a signal via its local allocator 210 to the global allocator 215 to free the physical memory 125A attached to certain VB-GMA pairs after capturing the data. Referring briefly back to FIG. 2 and FIG. 4, an application program 105 having PVM 225A (FIG. 2), or a module 105 executing on its behalf (e.g. a camera module 852) may wish to free the physical memory attached to virtual block 302D (FIG. 4).

Specifically, the module 105 (FIG. 2) may wish to free the last 250 MB within this virtual block 302D (FIG. 4). Such an application program 105 or camera module 852 may signal its local allocator 210 (see FIG. 2) with the virtual address of the 250 MB portion the program 105 wishes to free along with its size. The local allocator 210 may then translate memory request into the corresponding GMA address 304J (FIG. 4) and send this address along with the free instruction to the global allocator 215 (FIG. 2). The global allocator 215 (FIG. 2) may then forward this to the physical allocator 220 (FIG. 2), which would translate the address to the physical memory block 306K (FIG. 4) and deallocate this block 306K (FIG. 4) from physical memory, without making any changes to the VB-GMA allocation within the global address space 230 (FIGS. 2 & 4).

If GMAs addresses are sent as ranges of addresses, the granularization may be done either by the O/S 110 in software or by a specialized HW block in the physical allocator 220. The HW block for granularization may also be located in the global allocator 215 as understood by one of ordinary skill in the art.

In addition to GMA usage, the global allocator 215 may also track each application program's (i.e. user process') physical memory usage, either directly or by estimation. To track physical memory usage directly, the global allocator 215 tracks the owner of each line in the secondary memory devices 125B (i.e. on-chip caches, which are indexed using the global address space 230 of FIGS. 3-4).

When a page is allocated in the main memory device 125A, the owner of the line that triggered the memory allocation is sent back to the global allocator 215, which updates a physical memory counter in the application program's (i.e. user process') private page table stored in the global address space 230. The global allocator 215 can then use this data to directly inform the O/S 110 when application programs 105 (i.e. user processes) are using too much physical memory of the main memory device 125A.

Alternatively, the global allocator 215 may assign a statistical estimate of an application program's (i.e. a user process') physical memory usage based on its GMA allocations in the global address space 230 (see FIG. 4). This estimate may be calculated based on offline surveys of GMA-physical memory correlation for various kinds of workloads. Memory usage by an application program 105 (i.e. user process) may also be calculated by sampling a subset of processes' GMA and physical memory usage during execution, reducing the overhead of tracking owners for every line in the secondary memory devices 125B (i.e. on-chip caches).

The physical allocator 220 communicates with the global allocator 215 to manage physical memory of the primary memory device 125A by allocating and deallocating pages for global addresses in the global address space 230. The physical allocator may accelerate global-physical address translation using its own physical translation lookahead buffer (pTLB) 335.

This pTLB 335 designation (i.e. the letter “p”) is being used to distinguish this hardware from the TLB 310 hardware of the local allocators 210. As noted previously, one unique aspect of the system 101 is that the TLBs 310 of the local allocators 210 are mapping two virtual memory spaces 225, 230 together. Meanwhile, the pTLB 335 of the physical allocator 220 is functioning in the traditional/conventional sense of a translation lookahead buffer: by converting/mapping virtual memory space 230 to a physical memory space in the primary memory device 125A.

The pTLB 335 may store recently used translations from nearby secondary memory devices 125B that are indexed in the global address space 230, such as caches, TCMs, etc. The physical allocator 220 manages physical pages and allocates and deallocates them to/from GMAs of the global address space 230.

The physical allocator may receive writes or dirty evicts from the last-level on-chip caches 125B (i.e. secondary memory devices 125B) to physical memory 125A which are sent to the pTLB 335. The pTLB 335 may cache translations for recently accessed global addresses in the global address space 230.

If a requested global address is in the pTLB 335, its physical address is forwarded to the requestor (i.e. usually to the O/S 110) and the appropriate page may be accessed. If a translation is not in the pTLB 335, the memory request is sent to the physical page table manager 340 to query the physical page table 342. Depending on the organization of secondary memory devices 125B (i.e. caches 125B) relative to physical memory 125A, multiple pTLBs 335 may be required to service requests from different last-level caches 125B.

The physical page table manager 340 of the physical allocator 220 may manage the physical page table 342 and handles requests for global-physical address translations. If a requested global address has been previously allocated, its physical address is forwarded to the requestor and the data is written to an appropriate page in the main/primary memory device 125A. The pTLB 335 is also updated with this translation to speed up future requests.

If the global address requested has not been allocated in the global address space 230, a new physical address from a physical page pool 345 is selected, and then, the physical page table 342 as well as pTLB 335 are updated with this global-physical translation. The physical page table 342 may be statically allocated at fixed addresses within the global address space 230 or in physical memory of the primary memory device 125A. If the page table is in the global address space 230, then it may be cached within other structures that are addressed with the global address space 230.

To ensure that normal translation requests can proceed along with new allocations without deadlocking the system 101, special memory channels may be explicitly reserved for allocation requests and page table updates. These channels may also be used for communication between various pTLBs 335, when multiple pTLBs 335 are needed.

To optimize freeing ranges of global memory addresses, the physical page table 342 may be organized using tree-like data structures that allow for rapid invalidation of large chunks in the global address space 230. The physical allocator 220 will still be able to perform direct single-page invalidations if/when requested.

To free a page or a range of pages, the physical allocator 220 may first query the pTLB 335 for the appropriate translation. If the GMA translation is cached within the pTLB 335, then the physical addresses are returned to the physical page pool 345 and then, the physical page table manager 340 removes their entries from the physical page table 342.

If the GMA translation is not cached within the pTLB 335, then the physical page table manager 340 queries the physical page table 340, and returns the physical pages to the physical page pool 345, and removes/invalidates the GMA entries from the page table 342.

Alternatively, the free page instruction may be forwarded directly to the physical page table manager 340, which then sends invalidate requests to the pTLB 335 while removing the entries from the page physical page table 342. To prevent slowdowns for memory requests, the physical allocator 220 may prioritize normal data reads/writes over free page instructions. Multiple free page instructions may be coalesced together and processed in batches for increased speed and efficiency as needed.

Referring now to FIG. 6, this figure illustrates a signaling sequence/flow diagram 600 which provides a two stage parallel lookup performed by each local allocator 210 (see FIG. 5), in accordance with exemplary embodiments. A memory read/write request (block 602) in FIG. 6 may be generated by an application program 105 (see FIG. 5—i.e. “user process”) and sent to the local allocator 210.

Most of the events illustrated in FIG. 6 are performed by each local allocator 210. Requests for PVMs 225 are issued by application programs 105 and may be handled by a respective local allocator 210, with or without any intervention by/communication with the O/S 110. The O/S 110 may communicate with the global allocator 215 when an application program 105 is initially created to setup its PVM 225, and may also facilitate the allocation of new virtual blocks within the application's PVM during its execution..

A first stage (block 604) of the signaling sequence 600 checks to see if the translation for the global address of the variable-sized virtual block (VB) 302 (See FIGS. 3-4) that contains the requested address is already stored in a first portion TLB 310-1 of a TLB 310. One exemplary embodiment of a first portion TLB 310-1 of a TLB 310 is shown in FIG. 6. The first portion TLB 310-1 may comprise a column listing the start address of the virtual block 302, its respective size 606 (i.e. Bound), and its global memory address 304 (i.e. GMA).

If the translation for the virtual block of the memory request sent (block 602) exists in the first portion TLB 310-1 (block 610), the exact global address is calculated and supplied to the client (i.e. “yes” branch from decision block 610). Otherwise, the signal flow continues (i.e. “no” branch from decision block 610) to a VMA address decision block 612.

The second stage (block 603) of the signaling sequence 600, which may be performed in parallel with the first stage (block 604), may check to see if the VMA-size pair for the virtual block 302 that contains the address being requested (see block 608) is in the second portion TLB 310-2 of the TLB 310. This second portion TLB 310-2 may cache some of the start addresses of the virtual memory areas (VMAs) for the private virtual memory (PVM) 225 (see FIGS. 3-4) corresponding to the application performing the request in a first column 609 of a table. In a second column 611 of the table, each currently allocated size for each VMA may be provided corresponding with a respective VMA.

If the VMA that contains the requested virtual address is within TLB 310-2 (i.e. “yes” branch from decision block 612) the local allocator 210 may then determine if the requested virtual address is within the bounds of its VMA's allocated size. If the requested virtual address is out-of-bounds of its VMA's allocated size, then a virtual block 302 for this address has not been allocated (no branch from decision block 616) and the local allocator 210 may forward on the memory request (block 618) to its local GMA pool 315 to get a new global address for this virtual block

If the requested virtual address is within allocated bounds for its VMA, then its virtual block 302 has previously been allocated (yes branch from decision block 616). However, this virtual block translation is not contained in TLB 310-1 (no branch from decision block 610). This triggers a request from the local allocator 210 to the global allocator 215 to obtain the proper translation (620).

If the inquiry to decision block 612 is negative, this means that neither the virtual block 302 for the requested virtual address nor its VMA-size pair are cached within the TLB. This triggers a request 614 to the global allocator 215 to check the private page table 322 to determine whether or not the virtual block 302 has been allocated.

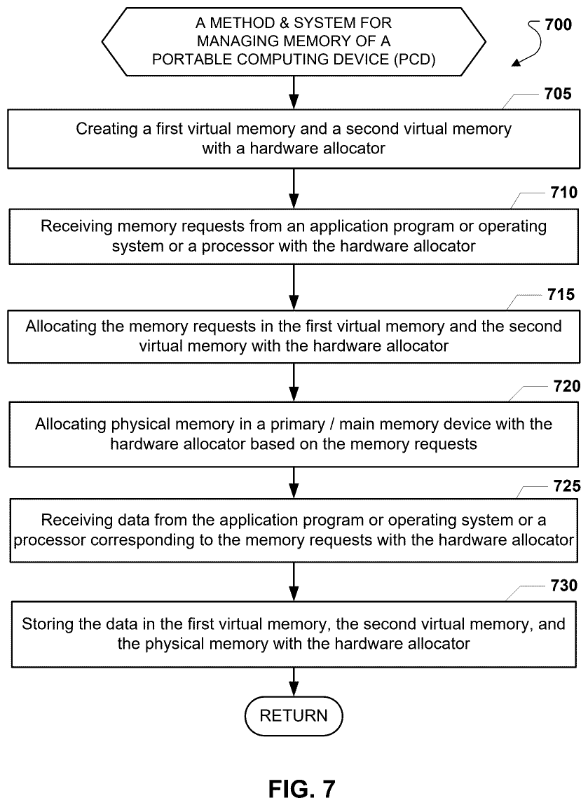

Referring now to FIG. 7, this figure illustrates a logical flow chart for a method 700 and system 101 for managing memory of a portable computing device (PCD) 800 according to one exemplary embodiment. The method 700 may include a first step/first block of creating a first virtual memory 225 (see FIGS. 2, 4-5) and a second virtual memory 230 (see FIGS. 2, 4-5) (see FIGS. 1-2, 5). This creating of the first and second virtual memories 225, 230 in block 705 may be performed by the hardware (HW) allocator 115 (see FIGS. 1-3, 5).

As noted previously, the first virtual memory 225 (see FIGS. 3-4) is mapped into the second virtual memory 230 (see FIGS. 3-4). The first virtual memory 225 or PVMs 225 may comprise variable-sized virtual blocks 302 (see FIGS. 3-4). Meanwhile, the second virtual memory 230 or global address space 230 (see FIGS. 3-4) may comprise equal sized blocks for storing memory.

Next, as indicated by block 710, the method 700 and system 101 may include receiving memory requests from an application program 105 and/or an operating system (O/S) 110 and/or processor 205 (see FIGS. 1-2, 5). This receiving of memory requests in block 710 may be performed by the hardware allocator 115. Specifically, the local allocators 210 and the global allocator 215 may perform this receiving of memory requests from the application program 105, the O/S 110, and the processor 205.

Subsequently, as presented by block 715, the method 700 and system 101 may include allocating the memory requests in the first virtual memory 225 (see FIGS. 2, 4-5) and a second virtual memory 230 (see FIGS. 2, 4-5). This allocation for the memory requests in block 715 may be performed by the hardware allocator 115.

Next, as indicated by block 720, the method 700 and system 101 may include allocating physical memory in a primary/main memory device 125A (see FIGS. 1-6). This allocating of physical memory in block 720 may be performed by the hardware allocator 115. Specifically, this allocating of physical memory in block 720 may be performed by the physical allocator 220 (see FIG. 5) that is part of the overall hardware allocator 115.

Subsequently, as shown by block 725, the method 700 and system 101 may include receiving data from an application program 105 and/or the O/S 110 and/or the processor 205 corresponding to the memory requests. This receiving of data from an application program 105 and/or the O/S 110 and/or the processor 205 in block 725 may be performed by the hardware allocator 110. Specifically, the local allocators 210 and global allocator 215 may perform this receiving of data from an application program 105 and the O/S 110 in block 725.

Next, as indicated by block 730, the method 700 and system 101 may include storing the data using virtual addresses for the first virtual memory 225 (FIGS. 1-4) and the second virtual memory 230, and using physical addresses for the physical memory of the main/primary memory device 125A. This storing of data in block 730 may be performed by the hardware allocator 115, and specifically, the local allocator 210, global allocator 215, and physical allocator 220 of FIG. 5. After block 730, the method 700 and system 101 may then return and repeat.

Referring now to FIG. 8, this figure illustrates an example of a portable computing device (PCD) 800 that may include, but is not limited to, a laptop or palmtop computer, a cellular telephone or smartphone, a personal digital assistant (PDA), a navigation device, a smartbook; a portable game console including an Extended Reality (XR) device, a Virtual Reality (VR) device, an Augmented Reality (AR) device, or a Mixed Reality (MR) device; a satellite telephone, an automotive device, an Internet-of-Things (IoT) device, etc.

The PCD 802 may include a system-on-chip (SoC) or a Printed Circuit Board (PCB) 802. The SoC 802 may include a CPU 205A, a GPU 205B, a digital signal processor (DSP) 205C, an analog signal processor 808, a RF transceiver that includes transceiver/modem subsystem 854. The CPU 205A may include one or more CPU cores, such as a first CPU core 805A, a second CPU core 805B, etc., through an Nth CPU core 805N.

The CPU 205A, GPU 205B, DSP 205C may each be coupled to a Network-on-Chip (NoC) 877. The NoC 877 may be coupled to the HW memory allocator 115 described previously. The HW memory allocator is coupled to the secondary memory 125B described previously and a DRAM controller 832. The DRAM controller is coupled to primary memory 125A. The one or more memories 125A, 125B may include both volatile and non-volatile memories, as described above. In addition, some components of the HW allocator 115 such as the local allocator 210 (FIG. 2) may reside within or be locally associated with the processor blocks such as the CPU 205A or the GPU 205B. For example, as illustrated in FIG. 8, a local allocator 210 may reside in/exist within the GPU 205B.

Examples of volatile memories include dynamic random access memory (DRAM) 125A, which may function as the primary memory device 125A as described above. The DRAM 125A may include a DRAM memory controller 832. Such memories 125A, 125B may be internal to the SoC 802, as in the case of the DRAM 830, or external to the SoC 802 (not shown). As noted above, the secondary memory devices 125B, relative to the primary memory device 125A, may comprise a plurality of cache(s), tightly coupled memory (TCM), and the like.

According to the system 101 which may be present in and supported by PCD 800, all physical memory access by the processor units 205A, 205B, 205C, including cores 805A-805C of multi-core CPU 205A will be processed through the HW memory allocator 115. As noted previously, the HW memory allocator 115 has a physical allocator 220 (not shown in FIG. 8, but see FIG. 5).

A display controller 810 and a touch-screen controller 812 may be coupled to the CPU 205A. A touchscreen display 814 external to the SoC 802 may be coupled to the display controller 810 and the touch-screen controller 812. The PCD 800 may further include a video decoder 816 coupled to the CPU 205A. A video amplifier 818 may be coupled to the video decoder 816 and the touchscreen display 814.

A video port 820 may be coupled to the video amplifier 818. A universal serial bus (USB) controller 822 may also be coupled to CPU 205A, and a USB port 824 may be coupled to the USB controller 822. A subscriber identity module (SIM) card 826 may also be coupled to the CPU 205A.

A stereo audio CODEC 834 may be coupled to the analog signal processor 808. Further, an audio amplifier 836 may be coupled to the stereo audio CODEC 834. First and second stereo speakers 838 and 840, respectively, may be coupled to the audio amplifier 836. In addition, a microphone amplifier 842 may be coupled to the stereo audio CODEC 834, and a microphone 844 may be coupled to the microphone amplifier 842.

A frequency modulation (FM) radio tuner 846 may be coupled to the stereo audio CODEC 834. An FM antenna 848 may be coupled to the FM radio tuner 846. Further, stereo headphones 850 may be coupled to the stereo audio CODEC 834. Other devices that may be coupled to the CPU 105 include one or more digital (e.g., CCD or CMOS) cameras 852.

The RF transceiver or modem subsystem 854 may be coupled to the analog signal processor 808 and the CPU 105. An RF switch 856 may be coupled to the modem subsystem 854 and an RF antenna 858. In addition, a keypad 860, a mono headset with a microphone 862, and a vibrator device 864 may be coupled to the analog signal processor 808.

The SoC 802 may have one or more internal or on-chip thermal sensors 870A and may be coupled to one or more external or off-chip thermal sensors 870B. An analog-to-digital converter controller 872 may convert voltage drops produced by the thermal sensors 870A and 870B to digital signals.

A power supply 874 and a power management integrated circuit (PMIC) 876 may supply power to the SoC 802. The power supply 874 may comprise a rechargeable battery or a capacitor, or any combination thereof.

Any memory or other non-transitory storage medium having firmware or software stored therein in computer-readable form for execution by processor hardware, as described in this disclosure, may be an example of a “computer-readable medium,” as the term is understood in the patent lexicon. It should be noted that the processes represented by the flow diagrams shown in FIGS. 6-7 may be modified or augmented in a number of ways within the scope of the present disclosure. That is, certain blocks/steps in the processes/methods 600, 700 described above naturally precede others for the methods 600 & 700 and system 101 to function as described.

However, the methods 600, 700 and system 101 are not limited to the order of the steps described if such order or sequence does not alter the functionality of the system 101 and methods 600 & 700. That is, it is recognized that some steps may be performed before, after, or parallel (substantially simultaneously with) other blocks/steps without departing from the scope of this disclosure. In some instances, certain blocks / steps may be omitted or not performed without departing from this disclosure as understood by one of ordinary skill in the art.

Further, words such as “thereafter”, “then”, “next”, etc. are not intended to limit the order of the blocks/steps illustrated in FIGS. 6-7. These words are simply used to guide the reader through the description of the exemplary methods 600-700 with the understanding that the sequence of blocks/steps may be adjusted depending upon a particular application of the methods 600-700 and/or system 101.

Implementation examples are described in the following numbered clauses:
1. A memory management system for a portable computing device, comprising:
   a processor executing an application program;
   an operating system for supporting functions of the processor and the application program; and
   a hardware allocator coupled to the operating system and the processor for receiving one or more memory requests from at least one of the operating system, the application program, and the processor; the hardware allocator allocating memory in a first virtual memory and in a second virtual memory based on the memory requests; the hardware allocator allocating physical memory in a main memory device based on the memory requests.
2. The memory management system of clause 1, wherein the first virtual memory is mapped into the second virtual memory.
3. The memory management system of clauses 1-2, wherein the first virtual memory comprises variable sized virtual blocks for supporting the memory requests.
4. The memory management system of clauses 1-3, wherein the first virtual memory is divided into a plurality of equal sized memory areas where each memory comprises the variable sized virtual blocks.
5. The memory management system of clauses 1-4, wherein the hardware allocator receives a memory deallocation request from at least one of the operating system, the application program, and the processor; and the hardware allocator deallocates the physical memory in the main memory device based on the deallocation request and without any changes made to the first virtual memory.
6. The memory management system of clauses 1-5, wherein the second virtual memory has equal sized virtual blocks for supporting the memory requests.
7. The memory management system of clauses 1-6, wherein the hardware allocator comprises a plurality of local allocators, each allocator is assigned to a single processor and supports the first virtual memory and the second virtual memory.
8. The memory management system of clauses 1-7, wherein the hardware allocator comprises a global allocator for managing the second virtual memory.
9. The memory management system of clauses 1-8, wherein the hardware allocator further comprises a physical allocator for allocating the memory requests in the main memory device for the memory requests.
10. The memory management system of clauses 1-9, further comprising a secondary memory device relative to the main memory device, the secondary memory device storing the first virtual memory and the second virtual memory.
11. The memory management system of clause 10, wherein the main memory device comprises dynamic random access memory (DRAM), and the secondary memory device comprises a cache.
12. A memory management method for a portable computing device, comprising:
   providing a processor and an operating system;
   coupling the operating system and the processor to a hardware allocator;
   with the processor, executing an application program;
   generating one or more memory requests with at least one of the processor, the application program, and the operating system;
   receiving the one or more memory requests with the hardware allocator;
   the hardware allocator allocating memory in a first virtual memory and in a second virtual memory based on the one or more memory requests; and
   the hardware allocator allocating physical memory in a main memory device based on the memory requests.
13. The memory management method of clause 12, further comprising mapping the first virtual memory into the second virtual memory.
14. The memory management method of clauses 12-13, further comprising providing the first virtual memory with variable sized virtual blocks for supporting the one or more memory requests.
15. The memory management method of clauses 12-14, further comprising dividing the first virtual memory into a plurality of equal sized memory areas where each memory comprises the variable sized virtual blocks.
16. The memory management method of clauses 12-15, further comprising the hardware allocator receiving a memory deallocation request from at least one of the processor, the application program, and the operating system; and the hardware allocator deallocating the physical memory in the main memory device based on the deallocation request and without any changes made to the first virtual memory.
17. A memory management system for a portable computing device, comprising:
   a plurality of processors;
   each processor executing an application program;
   an operating system for supporting functions of the processors and the application programs; and
   a hardware allocator coupled to the operating system and the processor;
   the hardware allocator further comprises a plurality of local allocators, each local allocator being assigned to a single, different processor;
   the hardware allocator receiving one or more memory requests from at least one of the operating system, an application program, and the processors; the hardware allocator allocating memory in a first virtual memory and in a second virtual memory based on the memory requests; the hardware allocator allocating physical memory in a main memory device based on the memory requests.
18. The memory management system of clause 17, wherein the first virtual memory is mapped into the second virtual memory.
19. The memory management system of clauses 17-18, wherein the first virtual memory comprises variable sized virtual blocks for supporting the memory requests.
20. The memory management system of clauses 17-19, wherein the hardware allocator receives a memory deallocation request from at least one of the operating system, an application program, and a processor; and the hardware allocator deallocates the physical memory in the main memory device based on the deallocation request and without any changes made to the first virtual memory.

Alternative embodiments for the methods 600, 700 and system 101 will become apparent to one of ordinary skill in the art to which the invention pertains in view of the present disclosure. And although selected aspects have been illustrated and described in detail, it will be understood that various substitutions and alterations may be made therein.

For example, the PVMs 225 of FIGS. 3-4 may function without fixed-size VMAs and this would impact the signal diagram of FIG. 6. In this situation without fixed-size VMAs, the local allocator 310 may consist only of the TLB 310 (i.e. just the first portion TLB 310-1 of FIG. 6, the second portion TLB 310-2 would not be present), which may cache VB-GMA pairs.

In this alternative exemplary embodiment without fixed-sized VMAs, virtual memory accesses will generally trigger a single lookup in the TLB 310 (i.e. just the first portion TLB 310-1 of FIG. 6) to determine if the requested virtual block 302 is present.

A miss in the TLB 310 which now does not use VMAs in this embodiment may lead to a page table lookup by the global allocator 215 (see FIG. 5) to determine whether the VB 302 has been allocated previously. New allocations, as well as page table updates, may be performed by the global allocator 215 from its global GMA pool 330.

These alternative embodiments as well as the original embodiments are consistent with the teachings of the entire disclosure as understood by one of ordinary skill in the art, and which are defined by the following claims.

What is claimed is:

1. A memory management system for a portable computing device, comprising:
a processor executing an application program;
an operating system for supporting functions of the processor and the application program; and
a hardware allocator coupled to the operating system and the processor for receiving one or more memory requests from at least one of the operating system, the application program, and the processor; the hardware allocator allocating memory in a first virtual memory and in a second virtual memory based on the memory requests; the hardware allocator allocating physical memory in a main memory device based on the memory requests.

2. The memory management system of claim 1, wherein the first virtual memory is mapped into the second virtual memory.

3. The memory management system of claim 1, wherein the first virtual memory comprises variable sized virtual blocks for supporting the memory requests.

4. The memory management system of claim 3, wherein the first virtual memory is divided into a plurality of equal sized memory areas where each memory comprises the variable sized virtual blocks.

5. The memory management system of claim 4, wherein the hardware allocator receives a memory deallocation request from at least one of the operating system, the application program, and the processor; and the hardware allocator deallocates the physical memory in the main memory device based on the deallocation request and without any changes made to the first virtual memory.

6. The memory management system of claim 1, wherein the second virtual memory has equal sized virtual blocks for supporting the memory requests.

7. The memory management system of claim 1, wherein the hardware allocator comprises a plurality of local allocators, each allocator is assigned to a single processor and supports the first virtual memory and the second virtual memory.

8. The memory management system of claim 1, wherein the hardware allocator comprises a global allocator for managing the second virtual memory.

9. The memory management system of claim 1, wherein the hardware allocator further comprises a physical allocator for allocating the memory requests in the main memory device for the memory requests.

10. The memory management system of claim 1, further comprising a secondary memory device relative to the main memory device, the secondary memory device storing the first virtual memory and the second virtual memory.

11. The memory management system of claim 10, wherein the main memory device comprises dynamic random access memory (DRAM), and the secondary memory device comprises a cache.

12. A memory management method for a portable computing device, comprising:
providing a processor and an operating system;
coupling the operating system and the processor to a hardware allocator;
with the processor, executing an application program;
generating one or more memory requests with at least one of the processor, the application program, and the operating system;
receiving the one or more memory requests with the hardware allocator;
the hardware allocator allocating memory in a first virtual memory and in a second virtual memory based on the one or more memory requests; and
the hardware allocator allocating physical memory in a main memory device based on the memory requests.

13. The memory management method of claim 12, further comprising mapping the first virtual memory into the second virtual memory.

14. The memory management method of claim 12, further comprising providing the first virtual memory with variable sized virtual blocks for supporting the one or more memory requests.

15. The memory management method of claim 14, further comprising dividing the first virtual memory into a plurality of equal sized memory areas where each memory comprises the variable sized virtual blocks.

16. The memory management method of claim 15, further comprising the hardware allocator receiving a memory deallocation request from at least one of the processor, the application program, and the operating system; and the hardware allocator deallocating the physical memory in the main memory device based on the deallocation request and without any changes made to the first virtual memory.

17. A memory management system for a portable computing device, comprising:
a plurality of processors;
each processor executing an application program;
an operating system for supporting functions of the processors and the application programs; and
a hardware allocator coupled to the operating system and the processor;
the hardware allocator further comprises a plurality of local allocators, each local allocator being assigned to a single, different processor;
the hardware allocator receiving one or more memory requests from at least one of the operating system, an application program, and the processors; the hardware allocator allocating memory in a first virtual memory and in a second virtual memory based on the memory requests; the hardware allocator allocating physical memory in a main memory device based on the memory requests.

18. The memory management system of claim 17, wherein the first virtual memory is mapped into the second virtual memory.

19. The memory management system of claim 18, wherein the first virtual memory comprises variable sized virtual blocks for supporting the memory requests.

20. The memory management system of claim 19, wherein the hardware allocator receives a memory deallocation request from at least one of the operating system, an application program, and a processor; and the hardware allocator deallocates the physical memory in the main memory device based on the deallocation request and without any changes made to the first virtual memory.
